(19) United States
(12) Patent Application Publication
(10) Pub. No.: US 2002/0178121 A1
(43) Pub. Date: Nov. 28, 2002

(54) Method for secure online transaction

(76) Inventors: Ming-Chung Sung, Taipei (TW); Yen-Hsueh Cheng, Taipei (TW); Geng-Hwang Twu, Taipei (TW)

Correspondence Address: Joseph A. Mahoney, MAYER, BROWN & PLATT, P.O. Box 2828, Chicago, IL, 60690-2828, US

(21) Appl. No.: 09/930,353

(22) Filed: Aug. 15, 2001

(30) Foreign Application Priority Data
May 25, 2001 (TW) 090112592

(51) Int. Cl. H04K 1/00; H04L 9/00; G06F 17/60

(52) U.S. Cl. 705/64

(57) ABSTRACT

The present invention provides an online transaction method for providing a user with an online transaction via a digital media in an online transaction system. The online transaction system comprises a certificate authority module, at lease one service provider module, at lease one management module and a transaction module. Each management module respectively has an authentication device and a transaction device. The authentication device is connected between the service provider module and the certificate authority module. The transaction device is connected between the service provider module and the transaction module.

The online transaction method comprises the following steps of registering a digital certificate in the certificate authority module by the user via the digital media for generating a log data, the certificate authority module outputting the log data to the authentication device of the management module in a predetermined period; inputting the digital certificate in the service provider module by the user via the digital media for generating a digital signature, the service provider module outputting the digital signature to the authentication device of the management module; authenticating the digital signature according to a predetermined procedure for generating an authentication code; verifying the effectiveness of the user's authentication in the service provider module, and providing the user with the online transaction for generating a corresponding first transaction data to the transaction module; processing the first transaction data in the transaction module for generating a second transaction data to the transaction device of the management module; recording the second transaction data in the transaction device, and outputting the second transaction data to the service provider module; and displaying the second transaction data in the service provider module. In the online transaction system of the present invention, the digital signature, the authentication code, the first transaction data and the second transaction data are respectively based on the digital certificate for encryption in the transmission process. Therefore, the security problems of online transactions can be greatly improved.

### FIELD OF THE INVENTION

The present invention relates to a method for an online transaction, and more particularly, to a method for a secure online transaction with a digital certificate.

### BACKGROUND OF THE INVENTION

In the internet world there are more online transactions provided for consumers. However, the security of the online transactions is still questioned by the consumers.

Although there are lots of online transaction methods proposed until today, the security of the online transaction is still insufficient and unaccepted. Conventional internet service provider (ISP) usually provides consumers with online transaction services by the way of combining its own online package with consuming websites. For example, consumers must purchase an online package with a predetermined deposit value from the ISP. The online package can be suited for paying the online fee and the online transactions. When consumers connect to the internet via network devices and purchase products provided by the consuming websites, ISP then deducts a specific amount from the deposit value of the online package according to the consumers' online time and the consuming amount. Finally, when the predetermined deposit value of the online package is run out, consumers can also update their deposit value of the online package by the credit card in the website of ISP.

Please refer to FIG. 1. FIG. 1 is a flow chart of an online transaction method 10 according to the prior art. A consumer purchases an online package with a predetermined deposit value from an ISP and connects to a consuming website via an network device for conducting an online transaction with a consuming amount. The conventional online transaction method 10 comprises the following steps.

S12: Input an account and a password both provided by the online package in the consuming website, and output the account and password to a computer system of the ISP.

S14: Conduct an account & password checking process in the computer system of the ISP according to a pre-stored data, wherein the pre-stored data comprises accounts & passwords of all online packages.

S16: If the account and password are correct, conduct a comparing process of the deposit value R and the consuming amount C.

S18: If the deposit value R is greater than or equal to the consuming amount C, deduct the consuming amount C from the deposit value R of the online package, and send a successful transaction massage to the consuming website.

S20: If the deposit value R is smaller than the consuming amount C, send a fail massage to the consuming website.

S22: If either the account or password is wrong, send a fail massage to the consuming website.

The online transaction method 10 of the prior art has following disadvantages. First, when consumers conduct online transactions via internet, their accounts and passwords must be transmitted on the internet. However, if the accounts and passwords are intercepted, it will lead to lots of security problems. Besides, the accounts and passwords of the online packages can be stolen easily. It always leads to unnecessary disputes among consumers, ISPs and consuming websites.

### SUMMARY OF THE INVENTION

It is therefore a primary objection of the present invention to provide a method for a secure online transaction to solve the above mentioned problems.

In a preferred embodiment, the present invention provides an online transaction method for providing a user with an online transaction via a digital media in an online transaction system. The online transaction system comprises a certificate authority module, at lease one service provider module, at lease one management module and a transaction module. Each management module respectively has an authentication device and a transaction device. The authentication device is connected between the service provider module and the certificate authority module. The transaction device is connected between the service provider module and the transaction module.

The online transaction method comprises the following steps of registering a digital certificate in the certificate authority module by the user via the digital media for generating a log data, the certificate authority module outputting the log data to the authentication device of the management module in a predetermined period; inputting the digital certificate in the service provider module by the user via the digital media for generating a digital signature, the service provider module outputting the digital signature to the authentication device of the management module; authenticating the digital signature according to a predetermined procedure for generating an authentication code; verifying the effectiveness of the user's authentication in the service provider module, and providing the user with the online transaction for generating a corresponding first transaction data to the transaction module; processing the first transaction data in the transaction module for generating a second transaction data to the transaction device of the management module; recording the second transaction data in the transaction device, and outputting the second transaction data to the service provider module; and displaying the second transaction data in the service provider module. In the online transaction system of the present invention, the digital signature, the authentication code, the first transaction data and the second transaction data are respectively based on the digital certificate for encryption in the transmission process.

It is an advantage of the present invention that the online transaction method provides an independent operation mechanism between the certification authentication process and the online transaction process, wherein the digital signature, certification identifier, the first transaction data, and the second transaction data are encoded based on the digital certification in the transmission process for improving the security of the online transaction.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a flow chart of an online transaction method according to the prior art.

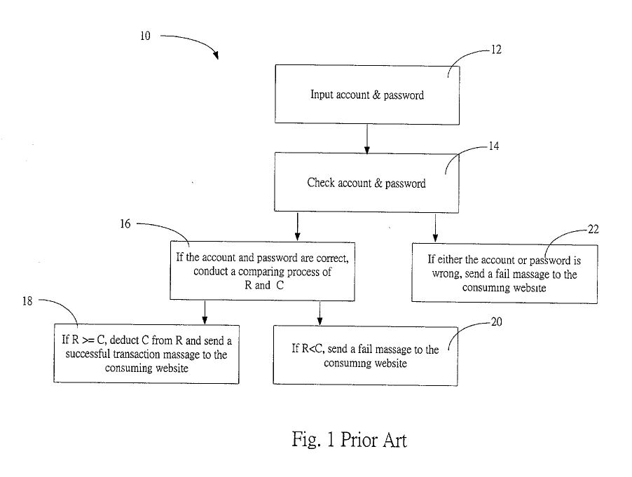

FIG. 2 is a schematic diagram of an online transaction system applied in the present invention.

FIG. 3 is a flow chart of an online transaction method according to the present invention.

FIG. 4 is a flow chart of another embodiment of the predetermined authentication process shown in FIG. 3.

### DETAILED DESCRIPTION OF THE PREFERED EMBODIMENT

An online transaction method 30 of the present invention applied in an online transaction system 32 provides a user with an online transaction via a digital media Dm through a network device 34. The digital media Dm can be a smart card or a biological identification device. The network device 34 can be a personal computer network device, a wireless network device or a Set-top Box.

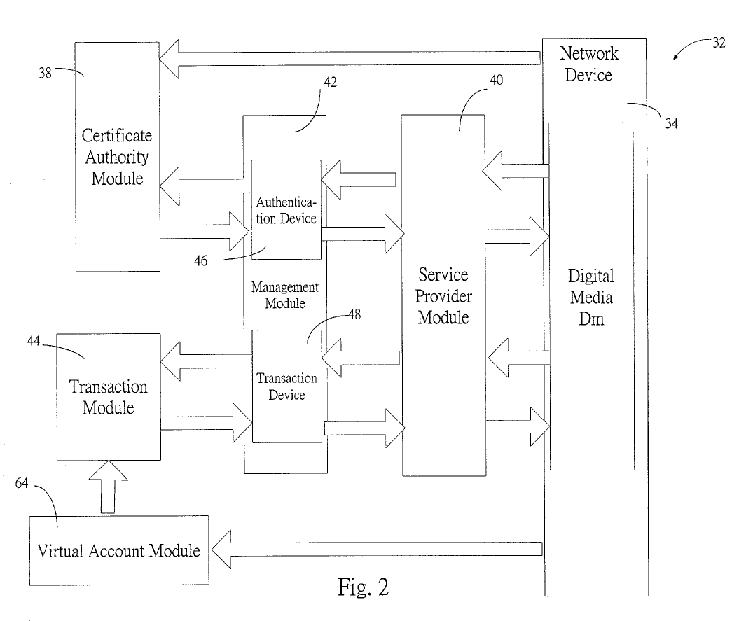

Please refer to FIG. 2. FIG. 2 is a schematic diagram of an online transaction system 32 applied in the present invention. The online transaction system 32 comprises a certificate authority module 38, a service provider module 40, a management module 42 and a transaction module 44. The service provider module 40 can be an Internet Service Provider (ISP) or an Internet Content Provider (ICP). The management module 42 has an authentication device 46 and a transaction device 48. The authentication device 46 is connected between the service provider module 40 and the certificate authority module 38. The transaction device 48 is connected between the service provider module 40 and the transaction module 44. The authentication device 46 and the transaction device 48 independently operate in the management module 42.

Besides, the online transaction system 32 further comprises a virtual account module 64 connected to the transaction module 44 for providing an account data corresponding to the digital media Dm, wherein the account data comprises a deposit value. The user can update the account data according to a predetermined method by an automated teller machine (ATM).

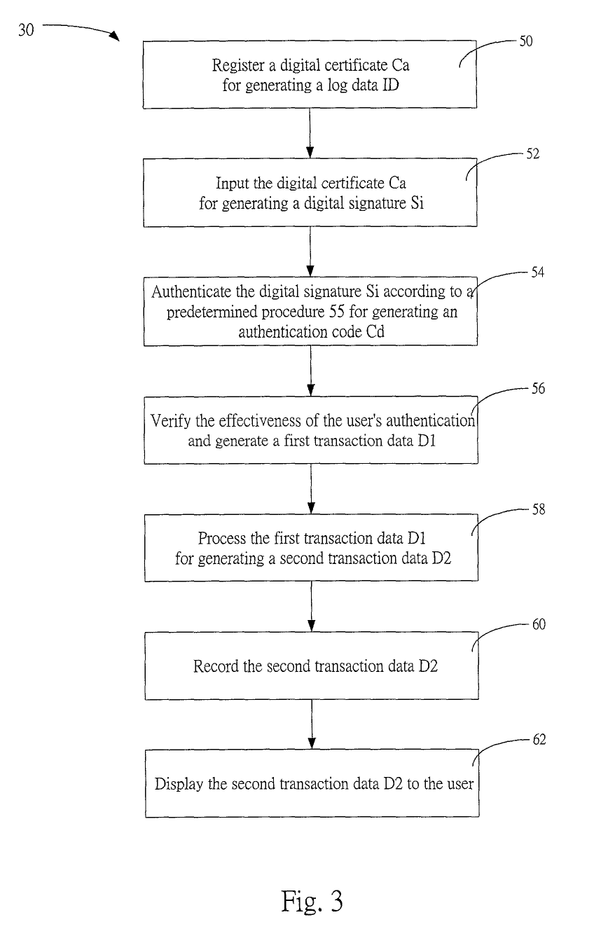

Please refer to FIG. 3. FIG. 3 is a flow chart of the online transaction method 30 according to the present invention. The online transaction method 30 according to the present invention comprises the following steps.

S50: Register a digital certificate Ca in the certificate authority module 38 by the user via the digital media Dm through the network device 34 for generating a log data ID. The certificate authority module 38 then outputs the log data ID to the authentication device 46 of the management module 42 in a predetermined period. The log data ID can comprise an active message of the digital media Dm and a certificate password Pw, or an active message of the digital media Dm, a certificate password Pw, and user's ID number & birthday. The certificate password Pw can be assigned by the certificate authority module 38 or set by the user.

S52: Input the digital certificate Ca in the service provider module 40 by the user via the digital media Dm through the network device 34 for generating a digital signature Si. The service provider module 40 then outputs the digital signature Si to the authentication device 46 of the management module 42.

S54: Authenticate the digital signature Si according to a predetermined procedure 55 for generating an authentication code Cd. The predetermined procedure 55 is that the digital signature Si is verified according to the log data ID in the authentication device 46.

S56: Verify the effectiveness of the user's authentication in the service provider module 40 according to the authentication code Cd, and provide the user with the online transaction for generating a corresponding first transaction data D₁ to the transaction module 44. The first transaction data D₁ can comprise the consuming amount, service item, transaction date, and service provider's code.

S58: Process the first transaction data D₁ in the transaction module 44 for generating a second transaction data D₂ to the transaction device 48 of the management module 42. The second transaction data D₂ can comprise a transaction result data or a fail message.

S60: Record the second transaction data D₂ in the transaction device 48, and output the second transaction data D₂ to the service provider module 40.

S62: Display the second transaction data D₂ to the user by the service provider module 40.

In the online transaction method 30 of the present invention, the digital signature Si, the authentication code Cd, the first transaction data D₁ and the second transaction data D₂ are respectively based on the digital certificate Ca for 1024 bits encryption in the transmission process.

In the S50 to S56 of the present invention, the user can register a digital certificate Ca and certificate password Pw in the certificate authority module 38 via the digital media Dm, and input the digital certificate Ca in the service provider module 40 via the digital media Dm for generating the digital signature Si. After the digital signature Si verified by the authentication device 46 of the management module 42, the service provider module 40 can verify the effectiveness of the user's authentication to proceed the transaction process.

In the S56 to S62 of the present invention, after the user accepts the online transaction, the service provider module 40 generates a corresponding first transaction data D₁ comprising a consuming amount. The transaction module 44 process the first transaction data D₁ according to corresponding deposit value to generate the second transaction data D₂, and store the second transaction data D₂ to the transaction device 48 of the management module 42. Finally the service provider module 40 displays the second transaction data D₂ to the user in the network device 34.

Thus, the online transaction method 30 according to the present invention provides an independent operation mechanism comprising a certification authentication process (S50-S56) and a transaction process (S56-S62). The digital signature Si, the authentication code Cd, the first transaction data D₁ and the second transaction data D₂ are respectively based on the digital certificate Ca for encryption in the transmission process. Therefore, the security problem of the online transactions can be greatly improved. Besides, the transaction module 44 of the online transaction method 30 according to the present invention can not only output the second transaction data D₂ to the transaction device 48 of the management module 42 in real time, but also output a batch of the second transaction data D₂ to the transaction device 48 of the management module 42 periodically. Thus the transaction device 48 can periodically compare the transaction result data in the second transaction data D₂ for preventing the transaction result data from being maliciously tampered.

According to another embodiment of the present invention, the online transaction system 32 can also comprise a plurality of management modules 42, wherein each management module 42 respectively manages a specific group of corresponding digital media Dm′. The user can register a digital certificate Ca′ in the certificate authority module 38 via the digital media Dm′ for generating a log data ID′. The log data ID′ will be separately and respectively saved in the certificate authority module 38 and the corresponding authentication device 46 of the management module 42. Thus, it can save the data transmit time and broaden the scope of transaction service to improve the service quality and reaction speed of the online transaction according to the present invention.

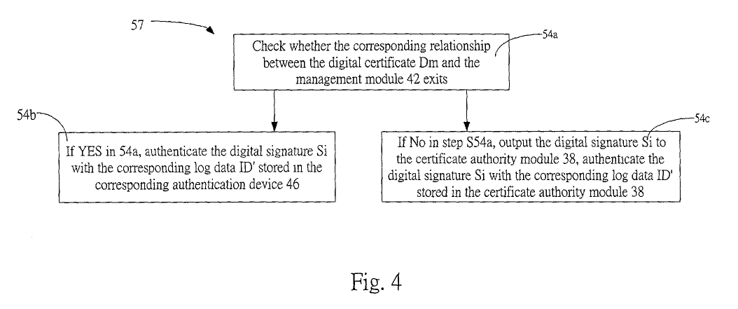

Please refer to FIG. 4. FIG. 4 is a flow chart of another embodiment of the predetermined authentication process 57 shown in FIG. 3. In the online transaction method 30 according to the present invention, the predetermined authentication process 57 of S54 can comprise the following sub-steps.

S54a: Check whether the corresponding relationship between the digital certificate Dm and the management module 42 exits.

S54b: If YES in S54a, authenticate the digital signature Si with the corresponding log data ID′ stored in the corresponding authentication device 46 for generating the authentication code Cd, and output the authentication code Cd to the service provider module 40.

S54c: If No in step S54a, output the digital signature Si to the certificate authority module 38, authenticate the digital signature Si with the corresponding log data ID′ stored in the certificate authority module 38 for generating the authentication code Cd, and output the authentication code Cd to the service provider module 40 through the authentication device 46.

In the S50 to S56 according to the present invention, the user can register a digital certificate Ca′ and certificate password Pw′ in the certificate authority module 38 via the digital media Dm′, and input the digital certificate Ca′ in the service provider module 40 via the digital media Dm′ for generating the digital signature Si. The service provider module 40 then output the digital signature Si to the corresponding authentication device 46 of the management module 42. The digital signature Si can be verified by the authentication device 46 of the management module 42, and then the service provider module 40 verifies the effectiveness of the user's authentication to proceed the transaction process.

Besides, if the service provider module 40 do not output the digital signature Si to the corresponding authentication device 46 of the management module 42 due to some reasons, the digital signature Si still can be verified by the log file ID′ saved in the certificate authority module 38 via the non-corresponding authentication device 46 of the management module 42.

Comparing to the online transaction method 10 of the prior art, the online transaction method 30 according to the present invention provides an independently operation mechanism comprising a certification authentication process (S50-S56) and a transaction process (S56-S62). The digital signature Si, authentication code Cd, first transaction data D₁ and second transaction data D₂ are respectively based on the digital certificate Ca for 1024 bits encryption in the transmission process. Therefore, the security problems of online transactions can be greatly improved.

Besides, the transaction module 44 of the online transaction method 30 according to the present invention can not only output the second transaction data D₂ to the transaction device 48 of the management module 42 in real time, but also output a batch of the second transaction data D₂ to the transaction device 48 of the management module 42 periodically. Thus the transaction device 48 can periodically compare the transaction result data in the second transaction data D₂ for preventing the transaction result data from being maliciously tampered.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An online transaction method for providing a user with an online transaction via a digital media in an online transaction system, the online transaction system comprising a certificate authority module, at lease one service provider module, at lease one management module and a transaction module, each management module respectively having an authentication device and a transaction device, the authentication device being connected between the service provider module and the certificate authority module, the transaction device being connected between the service provider module and the transaction module, the online transaction method comprising:
registering a digital certificate in the certificate authority module by the user via the digital media for generating a log data, the certificate authority module outputting the log data to the authentication device of the management module in a predetermined period;
inputting the digital certificate in the service provider module by the user via the digital media for generating a digital signature, the service provider module outputting the digital signature to the authentication device of the management module;
authenticating the digital signature according to a predetermined procedure for generating an authentication code;
verifying the effectiveness of the user's authentication in the service provider module, and providing the user with the online transaction for generating a corresponding first transaction data to the transaction module;
processing the first transaction data in the transaction module for generating a second transaction data to the transaction device of the management module;
recording the second transaction data in the transaction device, and outputting the second transaction data to the service provider module; and
displaying the second transaction data in the service provider module;
wherein the digital signature, the authentication code, the first transaction data and the second transaction data are respectively based on the digital certificate for encryption in the transmission process of the online transaction system.

2. The online transaction method of claim 1 wherein the authentication device and the transaction device independently operate in the management module.

3. The online transaction method of claim 2 wherein each management module respectively manages a plurality of corresponding digital media, the user registers a corresponding digital certificate in the certificate authority module via the corresponding digital media for generating a corresponding log data stored in the certificate authority module and the authentication device of the corresponding management module respectively.

4. The online transaction method of claim 3 wherein the predetermined procedure comprises the steps of:
(a) checking whether the corresponding relationship between the digital certificate and the management module exits; and
(b) if YES in step (a), authenticating the digital signature with the corresponding log data stored in the corresponding authentication device for generating the authentication code, and outputting the authentication code to the service provider module.

5. The online transaction method of claim 4 wherein if No in step (a), outputting the digital signature to the certificate authority module, authenticating the digital signature with the corresponding log data stored in the certificate authority module for generating the authentication code, and outputting the authentication code to the service provider module.

6. The online transaction method of claim 2 wherein the predetermined procedure comprises the step of authenticating the digital signature with the log data stored in the authentication device for generating the authentication code, and outputting the authentication code to the service provider module.

7. The online transaction method of claim 1 wherein the online transaction system further comprises a virtual account module connected to the transaction module for providing an account data, the user updating the account data according to a predetermined method.

8. The online transaction method of claim 7 wherein the predetermined method comprises the step of updating the account data by an automated teller machine.

9. The online transaction method of claim 1 wherein the digital media can be a smart card.

10. The online transaction method of claim 1 wherein the digital media can be a biological identification device.
